(19) United States
(12) Patent Application Publication
(10) Pub. No.: US 2017/0006827 A1
(43) Pub. Date: Jan. 12, 2017

(54) ANIMAL WASTE BAG DISPENSER

(71) Applicant: PROTECT ME ALERT SERIES N0: 8372683 CANADA INC., Mount Royal (CA)

(72) Inventor: Lorne Miller, Mount Royal, CA (US)

(21) Appl. No.: 15/202,920

(22) Filed: Jul. 6, 2016

Related U.S. Application Data
(60) Provisional application No. 62/189,492, filed on Jul. 7, 2015.

(51) Int. Cl. A01K 13/00; A01K 29/00; A01K 23/00

(52) U.S. Cl. CPC A01K 13/006; A01K 23/005; A01K 29/00

(57) ABSTRACT

An article of clothing containing an integrated waste bag dispenser is provided. A storage pouch having a plurality of slits configured to enable a waste bag to be withdrawn for use. As the waste bag dispenser is integrated with an article of clothing it provides an easy carrying mechanism for animal waste bags.

### CROSS-REFERENCE TO RELATED APPLICATIONS

The present application claims the benefit of U.S. Provisional Patent Application Ser. No. 62/189,492, which was filed on Jul. 7, 2015, by Lorne Miller for ANIMAL WASTE BAG DISPENSER, which is hereby incorporated by reference.

### BACKGROUND OF THE INVENTION

Many municipalities require dog owners to pick up animal waste products that are deposited in public when, for example, a dog owner is walking his or her pet. Some municipalities, parks or other areas may provide waste disposal bags. These waste disposal bags may be provided in a kiosk, etc., located in areas frequented by dog walkers. However, noted disadvantages of relying on publicly available waste disposal bags include, for example, vandalism to the kiosks, inadequate supplies stocked in the kiosk, etc. Thus, many dog walkers may not rely exclusively on waste disposal bags being publicly available when walking their dog.

As dog walkers and may not rely on waste disposal bags being available, they must bring their own waste disposal bags to be utilized. This may require the dog owner to remember to pack some waste disposal bags in his or her pocket or carry them in their hands. As will be appreciated, a noted disadvantage arises when a dog walker forgets to pack one or more waste disposal bags prior to heading out to walk their dog.

### SUMMARY OF THE INVENTION

The disadvantages of the prior art are overcome by providing an article of clothing that integrates an animal waste bag dispenser. Illustratively, the animal waste bag dispenser is integrated into an article of clothing designed to be worn by an animal, e.g., a dog. The waste bag dispenser illustratively comprises of a storage pouch configured to store one or more waste bags to be dispensed through a plurality of slits arranged on an exterior of the pouch.

### BRIEF DESCRIPTION OF THE DRAWINGS

The above and further advantages of the present invention may be described in relation to the following figures, in which like reference numerals indicate identical or functionally similar items:

FIG. 1 is a perspective view of an exemplary waste bag dispenser in accordance with an illustrative embodiment of the present invention;

FIG. 2 is a close up view of an exemplary waste bag dispenser in accordance with an embodiment of the present invention;

FIG. 3A is a detailed view of an exemplary waste bag dispenser in accordance with an illustrative embodiment of the present invention;

FIG. 3B is a detailed view of an exemplary waste bag dispenser in accordance with an illustrative embodiment; and

FIG. 3C is a detailed view of an exemplary waste bag dispenser in accordance with an illustrative embodiment of the present invention.

### DETAILED DESCRIPTION OF AN ILLUSTRATIVE EMBODIMENT

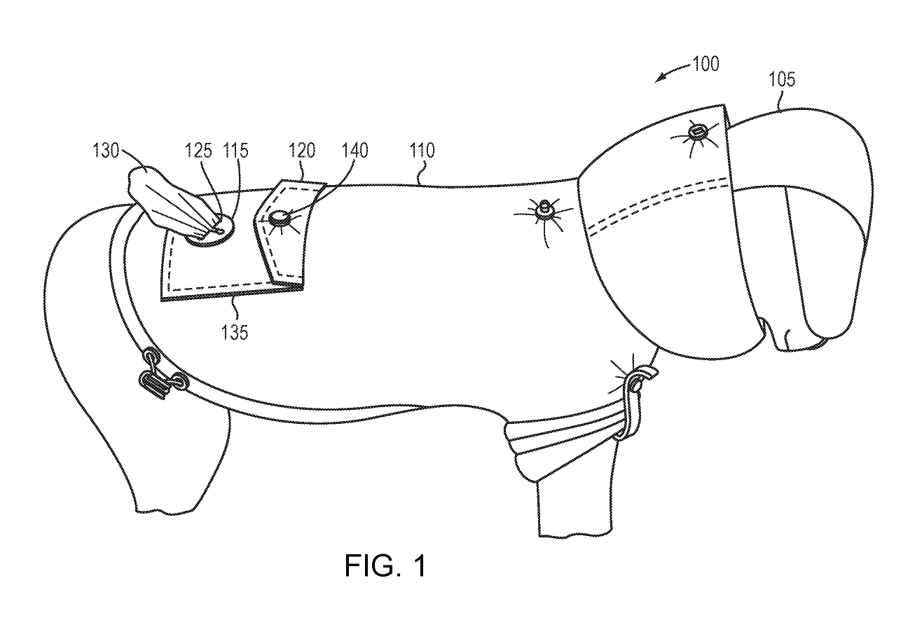

FIG. 1 is a perspective view of an exemplary waste bag dispenser in accordance with an illustrative embodiment the present invention. Illustratively, the perspective view 100 is of an animal 105 wearing a garment 110. Illustratively, the animal 105 is shown as a dog. However, in alternative embodiments of the present invention, the animal may be an animal other than a dog, such as a cat, rabbit, etc. Generally, any animal capable of wearing an article of clothing 110 may be utilized in various embodiments of the present invention. The article of clothing 110 is illustratively shown as a jacket or coat for animal 105. However, it should be noted that in alternative embodiments of the present invention, the article of clothing 110 may vary including, for example, a vest, costume etc. As such, the description and illustration contained herein of a jacket being the article of clothing 110 should be taken as exemplary only.

Operatively integrated with the article of clothing 110 is a waste bag dispenser in accordance with an illustrative embodiment of the present invention. The dispenser illustratively includes flap 120 that enables a user to insert/remove one or more waste bags 130 to be stored within the waste bag dispenser. Integrated into the surface of the waste bag dispenser is a pull through frame 115 that has a plurality of slits 125. Pull through dispenser base 115 is illustratively configured using the plurality of slits 125 to provide a friction on the waste bags 130 so that they will not exit the storage compartment in a manner that is undesired. For example, slits 125 may be arranged so that they provide enough frictional force that a human user is required to grasp a portion of the waste bag 130 and pull from the storage compartment 135 to remove it from the waste bag dispenser. At the same time, slits 125 will provide sufficient friction so that bags 130 will not simply fall out while the animal 105 is engaged in play activities.

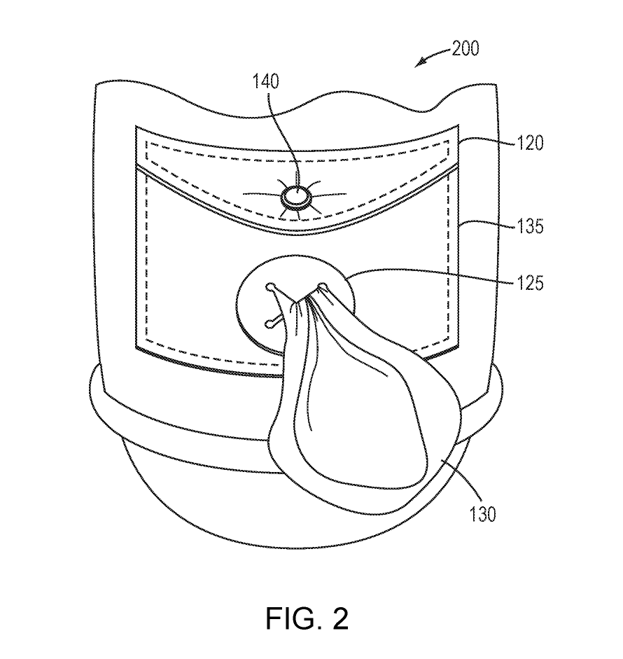

FIG. 2 is a more detailed view of an exemplary waste bag dispenser in accordance with an illustrative embodiment of the present invention. Waste bags 130 are shown protruding from the plurality of slits 125. The storage pouch 135 is shown as comprising an external pocket to article of clothing 110. However, it should be noted that in alternative embodiments, storage pouch may be located internally to the article of clothing 110. As such, the description of storage pouch being external should be taken as exemplary only. Similarly, storage pouch 135 is shown as having a substantially rectangular shape. As will be appreciated by those skilled in the art, the pouch may be made in varying shapes and/or sizes to accommodate aesthetics, desired size, carrying capacity, etc. As such, the description of a substantially rectangular storage pouch 135 should be taken as exemplary only.

FIG. 2 also shows a close-up of an exemplary flap 120 that is utilized to seal storage pouch 135. The flap 120 illustratively includes a fastener 140 that is used to secure the flap 120 to the pouch. In the illustrative embodiment shown and described in relation to FIG. 2, the fastener comprises a snap clasp. However, it should be noted that in alternative embodiments of the present invention, the fastener 140 may comprise any type of fastener suitable for securing the flap to the storage pouch including, but not limited to, buttons, clasps, zippers, etc. As such, the description of fastener comprising a snap clasp should be taken as exemplary only. Additionally, in the illustrative embodiment described herein, flap 120 is external to the article of clothing 110. In alternative embodiments a flap may be located on the internal side of the article of clothing. Such embodiments may include when, for example, storage pouch 135 is also located internally. Further, in certain alternative embodiments, there may not be a flap. One example of such an alternative embodiment is when storage pouch is closed or secured by a zipper. In such an embodiment, in overlapping flap is not required as the closing action of the zipper would secure the pouch 135.

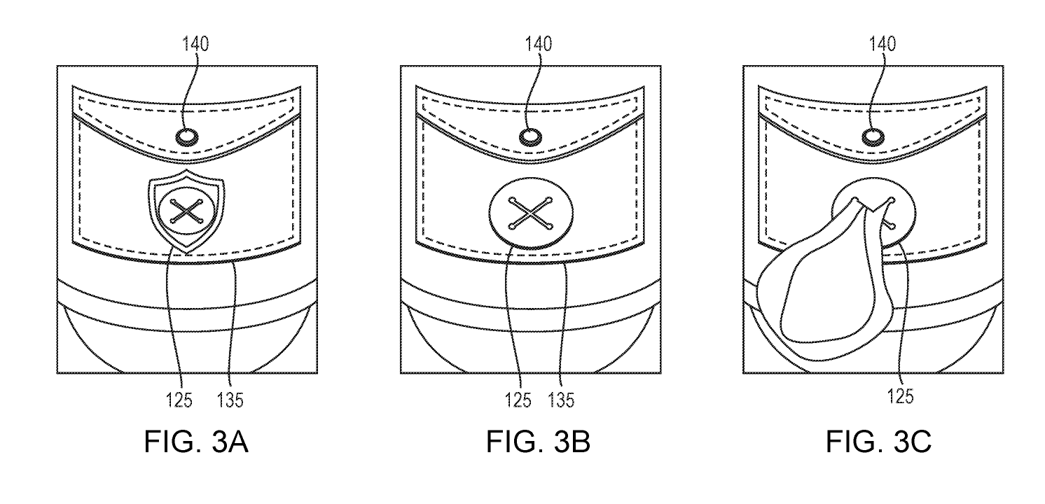

FIG. 3A is an exemplary view of an animal waste bag dispenser in accordance with an illustrative embodiment of the present invention. FIG. 3A shows an alternative design for dispenser base 115 in which slits 125 are created. It should be noted that while a shield shaped dispenser base 115 is shown, in contrast to the circular dispenser base 115 shown in FIG. 3B, the principles of the present invention may be utilized with any shaped dispenser base configured to support slits 125. In operation, the dispenser base 115 is illustratively comprised of a plastic or other hardened material that will retain its shape and provide the necessary friction rigidity for splits 125. By providing a dispenser base, is which may be integrated into the fabric in certain alternative embodiments, the necessary rigidity is obtained to achieve the friction necessary to prevent bags 130 from falling out of the waste bag dispenser. This can be seen in, for example FIG. 3C where the slits 125 provide sufficient friction to prevent waste bag 130 from slipping out of pouch 135.

In operation, a user will load a plurality of waste bags into pouch 135. Such bags may be purchased from commercial sources or may be recycled bags from, for example grocery stores. A first bag is illustratively poked through slits 125 so that a portion of the bag is external to the storage pouch 135. This portion may then be grasped by the user to remove the bag from the storage pouch. In accordance with an illustrative embodiment of the present invention, if the bags are arranged a particular order, the extraction of a first bag will pull an initial portion of a second bag through the slits so that it is ready to be dispensed.

The foregoing description describes certain exemplary embodiments. It will be apparent, however, that other variations and modifications may be made to the described embodiments, with the attainment of some or all of their advantages. Accordingly, the foregoing description is to be taken as exemplary only and not to otherwise limit the

What is claimed is:

1. An article of clothing comprising:
a body of the article of clothing;
a storage pouch integrated with the body of the article of clothing, the storage pouch configured to store one or more waste bags;
a dispenser disposed on the storage pouch, the dispenser having one or more slits extending from an interior of the storage pouch to an exterior of the storage pouch.

2. The article of clothing of claim 1 wherein the storage pouch is located on an interior of the body of the article of clothing.

3. The article of clothing of claim 1 wherein the storage pouch is located on an exterior of the body of the article of clothing.

4. The article of clothing of claim 1 wherein the body of the article of clothing comprises a coat.

5. The article of clothing of claim 1 further comprising a flap configured to secure the storage pouch when the flap is in a closed position.

6. The article of clothing of claim 5 wherein the flap is secured in the closed position by a fastener.

7. The article of clothing of claim 6 wherein the fastener comprises a snap clasp.

8. The article of clothing of claim 6 wherein the fastener comprises a button.
